(19) United States
(12) Patent Application Publication
(10) Pub. No.: US 2006/0201883 A1
(43) Pub. Date: Sep. 14, 2006

(54) Polymer matrixes having nanoscale channels and uses

(76) Inventors: William H. Hofmeister, Nashville, TN (US); David W. Wright, Nashville, TN (US)

Correspondence Address: NEEDLE & ROSENBERG, P.C., SUITE 1000, 999 PEACHTREE STREET, ATLANTA, GA, 30309-3915, US

(21) Appl. No.: 10/545,875

(22) PCT Filed: Feb. 18, 2004
(86) PCT No.: PCT/US04/04770

§ 371 Date: Aug. 17, 2005

Related U.S. Application Data
(60) Provisional application No. 60/448,578, filed on Feb. 19, 2003.

(51) Int. Cl. B29C 67/20; B01D 61/00

(52) U.S. Cl. 210/649; 264/49; 210/500.27; 436/178

(57) ABSTRACT

Disclosed herein are polymer matrixes having nanoscale channels dispersed therein and to methods for preparing such matrixes. Also disclosed are uses of such polymer matrixes, such as for separating and analyzing materials. Still further, disclosed are devices that include such polymer matrixes.

### CROSS-REFERENCE TO RELATED APPLICATION

This application claims priority to U.S. Provisional Application No. 60/448,578 filed Feb. 19, 2003, which application is incorporated by reference herein in its entirety.

### FIELD

This invention relates generally to polymer matrixes having nanoscale channels dispersed therein and to methods for preparing such matrixes. Further, the invention relates to uses of such polymer matrixes, such as for separating and analyzing materials. Still further, this invention relates to devices that include such polymer matrixes.

### BACKGROUND

The separation and characterization of materials, such as chemical compounds, is a common endeavor in chemical and biological research. Traditional approaches to separating and characterizing compounds involve techniques such as sodium dodecyl sulfate polyacrylamide gel electrophoresis (SDS-PAGE), size exclusion chromatography, reversed-phase HPLC, and capillary electrophoresis. However, many of these techniques have remained largely unchanged for decades and may not be readily suitable for the separation and characterization of newly identified materials. Moreover, these techniques are typically slow and limited to analyzing only a few samples at a time, and operate with relatively large sample volumes.

Recently, most areas of chemical and biological research have seen the number of samples to be analyzed dramatically increase, while sample size and time allotted for analysis has decreased. For example, in the pharmaceutical industry, where only one of 10,000 compounds makes it into and through clinical trials, the pursuit of new drugs can require the rapid handling of many thousand samples, which may be available in only minute quantities. As a result, there has been an increased focus on developing new devices and methods suitable for quickly separating and characterizing numerous materials. One such development has been the preparation and use of fluidic patterned devices.

Fluidic patterned devices, sometimes called “chips”, are typically planar devices that contain patterns of channels and wells in which and through which fluids, compounds, reagents, and samples can pass. These devices commonly have fluidic channels on the microscale, which are fabricated using standard photolithographic, etching, deposition techniques, and molded polydimethyl siloxane (Thorsen, T., Maerkl, S. J., Quake, S. R., Science (2002) 298, 580; Jacobson, S. C., Culbertson, C. T., Daler, J. E., and Ramsey, J. M., Analytical Chemistry (1998) 70, 3476). While such devices are gaining in use, the demands for increased efficiency, flexibility, and sensitivity are ever present. Structures with decreasing spacings, that is, smaller than microscale, could be used as molecular filters, providing size separation of many diverse materials, including biomolecules.

It is, therefore, desirable to create and use devices that contain channels on the nanometer scale, that is, nanoscale. The use of such nanoscale channels could greatly improve the efficiency, flexibility, sensitivity, and speed with which material detection, separation, and/or characterization are performed. The present invention addresses these objectives.

### SUMMARY

In accordance with the purpose(s) of this invention, as embodied and broadly described herein, this invention, in one aspect, relates to methods for making polymer matrixes having nanoscale channels. Still further, the invention relates to methods of separating and characterizing materials utilizing the polymer matrixes. In another aspect, the present invention relates to devices, such as chips and columns, prepared from such polymer matrixes and to methods of separating materials using these devices.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF DRAWINGS

The accompanying drawings, which are incorporated in and constitute a part of this specification, illustrate several embodiments of the invention and together with the description, serve to explain the principles of the invention.

FIG. 1 is a schematic of a device that can be used to solidify a two-component polymer mixture by directional solidification or nucleation and growth of spherulites.

FIG. 2 is a schematic of the heating/cooling block that can be used in the device shown in FIG. 1 to solidify the two-component polymer mixture. The front view is labeled “A” and the side views are labeled “B”.

FIG. 3 is a schematic of the sample holder that can be used to hold the sample in the device shown in FIG. 1. A side view is labeled “A” and an expanded top-side view is labeled “B”.

FIG. 4 is a graph of the growth velocity of a blend of 50% PEO and 50% PMMA as a function of isothermal growth temperature.

FIG. 5 is a polarized light micrograph of a spherulite that nucleated at an air bubble and grew from that location.

FIG. 6 is a schematic of how the polymer matrix could be used in a fluidic system to filter the contents of a lysed cell.

### DETAILED DESCRIPTION

The invention herein may be understood more readily by reference to the following detailed description of specific aspects of the materials and methods and the Examples included therein and to the Figures and the previous and following description.

But before the present invention is disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

As used in the specification and the appended claims, the singular forms “a”, “an,” and “the” include plural referents unless the context clearly dictates otherwise. Thus, for example, reference to “an amorphous phase” includes mixtures of one or more amorphous phases, reference to “a polymer” includes mixtures of one or more such polymers and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where the event or circumstance occurs and instances where it does not.

“Nanoscale” or “nanometer scale” means that at least one dimension (e.g., length, width, height, diameter, etc.) is less than about 1 micrometer (μm).

The present invention, in one aspect, provides a method of making a polymer matrix having nanoscale channels comprising the steps of: (a.) selecting a first and a second polymeric component each having a melting temperature; (b.) mixing the first and second polymeric components under conditions sufficient to provide a substantially homogeneous polymer mixture; (c.) solidifying one or both of the polymeric components to provide a pre-matrix wherein the second polymeric component is at least partially crystalline; (d.) removing at least a portion of the second polymeric component from the pre-matrix, thereby providing a polymer matrix having nanoscale channels.

Nanoscale Channels

The channels in the polymer matrix of the present invention are on the nanometer scale. The nanoscale channels can be formed, for example, by controlling the solidification (e.g., by controlling the solute diffusivity, temperature diffusivity, strain rate, mole fraction, temperature gradient, and/or growth velocity) of a two-component polymer mixture, wherein, in the mixture, both of the polymer components are present in their substantially non-crystalline forms. As used herein, “substantially non-crystalline” means that the components are suitably amorphous such that, when mixed together to provide the two-component polymer mixture, a substantially homogenous polymer mixture is provided.

The nanoscale channels in the matrixes of the present invention can have a variety of shapes, which will depend on the particular mode of solidification of the polymer matrix and of the identity of the polymers selected. Typically, the nanoscale channels are characterized as spaces or voids within the polymer matrix through which fluids or fluid-like materials can pass from one end of the polymer matrix to another.

The nanoscale channels of the present invention can have at least one dimension (e.g., diameter, length, width, height, etc.) less than about 1 micrometer (1000 nanometers), less than about 500 nanometers, less than 100 nanometers, and/or less than 10 nanometers. In one aspect, the nanoscale channels can have at least one dimension in the range of from about 1 to about 10 nanometers, and/or from about 10 to about 100 nanometers. In another aspect, the nanoscale channels can have at least one dimension in the range of about 1, 2, 5, 10, 15, 25, 50, 100, 125, 150, 200, 250, 500, 750, or 1000 nanometers, where any of the stated values can comprise an upper or lower endpoint, as appropriate. In yet a further aspect, the nanoscale channels can have varying dimensions or tapered, e.g., being larger at one position than another. When such tapering channels are used, the channel dimensions can start at greater than nanoscale but become smaller along the length of the channel so that at some location along the channel, the channel will become nanoscale as defined herein.

The two-component polymer mixture can comprise a first polymeric component and a second polymeric component. The polymer matrix having nanoscale channels can be prepared by solidifying the two-component polymer mixture and subsequently removing of all or a part of the second polymeric component from a pre-matrix. The first and second polymeric components should not be identical.

The two-component polymer mixture is not a colloid. Sometimes a colloid may assemble and be called “crystalline” because the separate units have long-range order. However, the assemblies are not formed by solidification nor are they crystalline, as would be understood by one of ordinary skill in the art. That is, ordering of colloids is not a first order phase transformation that occurs across an interface, like solidification, i.e., crystallization.

Also, the two-component polymer mixture is not a polymerizable gel. Polymerization is the linking of molecular subunits into longer chains of polymers, or, in some contexts, the cross-linking by reaction chemistry of individual polymer chains to each other. Thus, polymerization is different from solidification.

Further, the two-component polymer mixture is not a foam.

As noted, in accordance with the present invention, the two-component polymer mixture comprises a first and second polymeric component. Either the first, second, or both polymeric components of the two-component polymer mixture can be made of a single polymer or mixtures of polymers. Also, either the first, second, or both polymeric components can be homopolymers or copolymers (e.g., random copolymers, graph copolymers, block copolymers, and the like). Further, the first polymeric component can be connected to the second polymeric component by a covalent bond, e.g., a block copolymer of the first and second polymer components.

As used herein, the “second polymeric component” is that aspect of the two-component polymer mixture that is removed from the pre-matrix (as this is defined herein) so as to provide the nanoscale channels.

Suitable polymers for the first and second polymeric components are readily available from commercial sources and/or can be prepared by methods known to those of ordinary skill in the art. For example, suitable polymers can be found in Wunderlich, B., “Macromolecular Physics: Crystal Melting,” Academic Press, 1980; Wunderlich, B. ed., “Conformational Motion and Disorder in Low and High Molecular Mass Crystals (Advances in Polymer Science 87),” Springer Verlag, 1988; and Wunderlich, B., “Macromolecular Physics: Crystals, Structure, Morphology and Defects,” Academic Press, 1976, which references are incorporated herein by this reference for their teachings of crystalizable polymers.

Specific examples of polymers suitable for use in the first and second polymeric components of the two-component polymer mixture can include, but are not limited to, modified or unmodified polyolefins, polyethers, and polyalkylene oxides. More specific examples of suitable polymers can include, but are not limited to, one or more of: modified or unmodified polyethylene, polypropylene, polystyrene, poly(meth)acrylate, polymethyl(meth)acrylate, polyethylene oxide, polypropylene oxide and polybutylene oxide. With respect to the polyethylene and polypropylene, metallocene derived polymers may be used.

The term “modified” is used herein to describe polymers and means that a particular monomeric unit that would typically make up the pure polymer has been replaced by another monomeric unit that shares a common polymerization capacity with the replaced monomeric unit. Thus, for example, it is possible to substitute diol residues for glycol in poly(ethylene glycol), in which case the poly(ethylene glycol) will be “modified” with the diol.

Selection of the first and second polymeric components of the two-component polymer mixture can be made by one of ordinary skill in the art based on the characteristics of the first and second polymeric component, the particular end use purposes of the polymer matrix having nanoscale channels, the methods of generating those channels (e.g., by considering the solidification properties of the polymeric components and/or the ability to remove the second polymeric component from the first), the particular solvent used, or based on convenience.

In accordance with the invention herein, the second polymeric component has properties that allow it to be removed from the first polymeric component by solvent, heat, electromagnetic radiation, or a combination thereof, as discussed in more detail herein.

Another factor that should be considered when selecting the polymeric components is compatibility. For example, the polymeric components should be compatible with the particular analytes and reagents with which the polymer matrix can be used and come in contact with. The polymeric components should also be compatible with any substrates to which they are affixed. That is, the polymeric components should not chemically react with a substrate, reagent, analyte, etc. in a way that will hinder formation of the nanoscale channels or degrade those nanoscale channels once they are formed.

When selecting the two polymeric components for the polymer mixture, the polymeric components should also be miscible with each other in their substantially non-crystalline phases at some temperature but be immiscible at some point. For example, when heated to a certain temperature, the first and second polymeric components can be completely miscible in each other, so as to provide a substantially homogenous polymer mixture. However, when cooled, for example, the first polymeric component can become crystalline, substantially crystalline, or semi-crystalline so as to become immiscible with the second polymeric component. In accordance with this aspect, the second polymeric component can also be in a crystalline, substantially crystalline, or semi-crystalline state or remain in a substantially amorphous state.

The first and second polymeric components should not form a colloid, a polymerizable gel, or a foam.

Determining such characteristics and properties of the polymeric components is within the skill of one of ordinary skill in the art and does not require undue experimentation. In particular, polymer mixtures have become increasingly important in recent years in the fabrication of high performance polymers. For such polymers, regions of miscibility and immiscibility must be known and pseudo binary and ternary phase diagrams have been constructed for a number of polymer systems (Winey, K. I., Berba, M. L., Galvin, M. E., Macromolecules (1996) 29, 2868; Sasaki, H., Bala, P. K., Yoshida, H., Ito, E., Polymer (1995) 36, 25, 4805, which are each incorporated by reference herein for its teachings of polymer mixtures and for miscibility and phase transition data).

As previously noted, of particular interest for the present invention are miscible polymeric systems where at some temperature one polymeric component is crystalline or substantially crystalline and the other polymeric component is amorphous or substantially amorphous (Debier, D., Jones, A. M., Legras, R., J. Polymer Sci. (1998) 36, 2197, which is incorporated by reference herein for its teachings of polymer mixtures and for miscibility and phase transition data).

In one aspect, the first polymeric component can comprise polyalkylene oxide, in particular, polyethylene oxide (PEO) and the second polymeric component can comprise a polyolefin, in particular, poly(methyl)methacrylate (PMMA). In another aspect, the first polymeric component and the second polymeric component form a PEO-PMMA block copolymer. In still another aspect, the first polymeric component can be polystyrene (PS) and the second polymeric component can be PMMA. In yet another aspect, the first polymeric component and the second polymeric component form a PS-PMMA block copolymer. PS-PMMA polymer mixtures have been used to create nanoscale patterning by spinodal decomposition (Thurn-Albrecht et al., Adv. Materials (2000) 12(11): 787-791 and Guarini et al., Adv. Materials (2002) 14(18):1290-1294, each of which are incorporated by reference herein for their teachings of PS-PMMA polymer mixtures). When such first and second polymeric components are selected for the polymer mixture, they are miscible at an elevated temperature where both polymers are in their respective amorphous (or liquid) phases. However, when cooled, the second polymeric component will become immiscible in the first polymer. Put another way, when heated to a temperature above the phase transition point of the highest melting polymer, the two polymeric components provide a substantially homogenous polymer mixture; when cooled to a temperature at least below the highest melting temperature, the polymeric components begin to become immiscible.

Still further, one of ordinary skill in the art would be readily able to determine the crystalline, substantially crystalline, semi-crystalline, and amorphous phase characteristics of numerous polymers by reviewing publicly available information. Such characteristics may readily be used to predict what polymers may be suitable for use in the invention herein.

Additionally, even if the characteristics of one or more of the polymeric components to be used in the invention herein are not precisely known using publicly available sources, such characteristics may be determined by heating the two polymeric components and mixing them as discussed further herein. Thus, while there are a great number of polymer combinations that may be suitable for use in the present invention, such suitable polymer combinations can be readily determined by one of ordinary skill in the art without undue experimentation.

The volume fraction of the polymer matrix and nanoscale channels can be controlled by selecting the volume fractions of the first and second polymeric components in the polymer mixture. For example, a two-component polymer mixture with about a 50:50 volume fraction ratio of first and second polymeric components can yield, after solidification and removal of all of the second polymeric component, a polymer matrix where about half the volume is the crystalline or semi-crystalline first polymeric component and about half the volume is the nanoscale channels. If a 25% first polymeric component to 75% second polymeric component ratio were used, then approximately 25% of the volume would be the polymer matrix and approximately 75% the nanoscale channels. Similarly, the molecular weight fraction of the components in a block copolymer would control the volume of nanoscale channels in the crystallized system.

The two-component polymer mixture can comprise at least about 5% of the first polymeric component. The polymer mixture can comprise about 10, 20, 30, 40, 50, 60, 70, 80, or 90% of the first polymeric component, where any of the stated values can comprise an upper or lower endpoint, as appropriate. The polymeric mixture can comprise about 15, 25, 35, 45, 55, 65, 75, 85, or 95% of the first polymeric component, where any of the stated values can comprise an upper or lower endpoint, as appropriate. The polymeric mixture can comprise less than about 99%, or less than about 97% of the first polymeric component. The polymeric mixture can comprise about 7, 14, 21, 28, 34, 42, 49, 56, 63, 77, 84, or 91% of the first polymeric component, where any of the stated values can comprise an upper or lower endpoint, as appropriate.

The two-component polymer mixture can comprise at least about 5% of the second polymeric component. The polymer mixture can comprise about 10, 20, 30, 40, 50, 60, 70, 80, or 90% of the second polymeric component, where any of the stated values can comprise an upper or lower endpoint, as appropriate. The polymeric mixture can comprise about 15, 25, 35, 45, 55, 65, 75, 85, or 95% of the second polymeric component, where any of the stated values can comprise an upper or lower endpoint, as appropriate. The polymeric mixture can comprise less than about 99%, or less than about 97% of the second polymeric component. The polymeric mixture can comprise about 7, 14, 21, 28, 34, 42, 49, 56, 63, 77, 84, or 91% of the second polymeric component, where any of the stated values can comprise an upper or lower endpoint, as appropriate.

As would be recognized by one of ordinary skill in the art, it is important to obtain a thorough mixing of the two polymers in order to result in a polymer matrix having suitable nanoscale channeling according to the uses discussed herein. That is, it is important to obtain a substantially homogenous polymer mixture prior to conducting the solidification step. For example, if a thorough mixing is not obtained, when the second polymeric component is removed from the first polymeric component, it is currently understood that there will not likely be a uniform channeling in the matrix.

Accordingly, it is currently believed by the inventors herein that, in one aspect, the two polymeric components should be heated as a mixture above a temperature at which the two polymers are substantially non-crystalline, for example, in a liquid-like state, and are miscible. Further, it is believed necessary to apply a mixing operation to the mixture in a manner suitable to result in an evenly dispersed system, i.e., a substantially homogeneous mixture. As used herein, “substantially homogenous mixture” means that, for example, in a mixture having 25% of a first polymeric component and 75% of a second polymeric component, a sampling of the mixture at any location will provide about 25% and about 75% of the first and second polymeric components, respectively.

Suitable mixing can be accomplished with a static mixer, a mechanical mixer, a magnetic mixer and stir bar, a shaker, air agitation and the like. Such mixing methods are within the knowledge of one of ordinary skill in the art and so are not discussed in detail herein. In one aspect, the two-component polymer mixture is mixed with a mechanical stirrer for one day at a temperature above the melting point of the polymeric component with the highest melting point (but below the decomposition point of the polymeric component with the lowest melting point). In another aspect, the first and second polymeric components are mixed while heating to a temperature greater than the melting temperature of the polymeric component having the highest melting temperature.

Additionally, it is also currently believed by the inventors herein that suitable mixing of the two polymeric components can occur with the use of a solvent in which each polymer is soluble or miscible. In such an aspect, the polymers may be dissolved or made miscible and the dissolved polymeric materials mixed thoroughly to form a substantially homogeneous mixture. The solvent may then be removed according to suitable methods, such as by vacuum extraction, thus leaving a fully mixed two-component mixture. Alternatively, it may be appropriate in some circumstances to have the solvent present during solidification.

The choice of solvent would depend on the particular polymeric components. Suitable solvents that can be used can include, for example, one or more of water, dioxane, dichloromethane, chloroform, 1,2-dichloroethane, 1,1,1-trichloroethane, N,N-dimethylformamide (DMF), N,N-dimethylacetamide, dimethylsulfoxide (DMSO), acetonitrile, ethyl acetate, ether, benzene, toluene, or xylene. Suitable mixtures of any of these materials may also be utilized.

When fully mixed, that is, when the polymers are present as a substantially homogenous polymer mixture such that the polymeric components are miscible, one or both polymeric components of the polymer mixture can then be solidified. As used herein, solidification is the self-assembly of compounds as they transition from an at least substantially non-crystalline phase to a substantially crystalline phase. In solidification, the crystalline phase typically nucleates from the substantially non-crystalline polymer form, and the subsequent crystal growth is called solidification. This first order phase transition, that is, a change of state from liquid to solid by the formation of crystals near the composition of the liquid, is accompanied by the release of the latent heat of fusion. Solidification can result in three-dimensional symmetry.

In solidification, a phase grows by addition from the liquid to the solid across an interface such that phases are continuous. The inventors herein have found that in coupled growth of two crystalline phases, or one substantially crystalline phase and a substantially non-crystalline phase, the removal of the second phase results in nanoscale channels through the crystalline structure.

Solidification is a broad field of research; however, for the purposes of this disclosure, solidification can be delineated into more specific categories such as 1) directional solidification and 2) nucleation and growth of spherulites.

In directional solidification, a sample is typically moved though a temperature gradient from a warm side, where the sample is at least substantially non-crystalline or above the melting temperature of the sample, into a cooler side, where the sample becomes solidified, such as by becoming substantially crystalline. This results in the sample solidifying in a specific and predictable direction. Careful design of the pulling velocity and/or thermal gradient will give rise to an ever-decreasing spacing of the crystalline and non-crystalline (i.e., amorphous or partially amorphous) phases. For example, a thin polymer mixture can be placed between two plates and solidified in a temperature gradient.

The particular temperature gradient that can be used for directional solidification will depend on the particular polymeric components present in the two-component polymer mixture. For example, the substantially homogenous two-component polymer mixture should be subjected to a temperature gradient at which both polymers are at least substantially non-crystalline at the beginning of the gradient and the gradient should end at least at a temperature where at least one polymeric component solidifies and becomes substantially crystalline. Still further, both polymeric components can be solidified at the end of the gradient.

Suitable thermal gradients can be as high as 100° C. per mm or growth can occur in isothermal conditions. In one aspect, the thermal gradient can be about 1, 5, 10, 15, 20, 25, 30, 35, 40, 45, 50, 55, 60, 65, 70, 75, 80, 85, 90, 95, or 100° C. per mm, where any of the stated values can form an upper and/or lower endpoint when appropriate. In another aspect, the thermal gradient can be from about 1 to about 30° C. per mm, from about 5 to about 20° C. per mm, or about 10° C. per mm.

Also, the gradient and pull rates could be changed to vary the inter lamellar spacing in the length of the sample. For example, suitable pull rates can be started at about 1 μm per hour and increased to about 30 μm per hour to produce a sample with progressively smaller channels in a constant gradient, and/or the gradient could be modulated to produce the desired changes in channel width. In one aspect, the pull rate can be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 μm per hour, where any of the stated values can form an upper and/or lower endpoint when appropriate. The pull rate can be also be held constant throughout the solidification process or, as noted, it can be varied.

Directional solidification can also be induced by application of a mechanical strain or a shear flow. It is believed by the inventors herein that unidirectional strain causes macromolecules to align, thus reducing the barrier to nucleation and crystal growth and increasing the likelihood and stability of the crystalline phase. This alignment of polymers forces the alignment of the crystalline phase (Raesiaka, J. and Kovacs, A. J., J. Appl. Phys. (1961) 32, 2314; Hill, M. J. and Keller, A., J. Macromol. Sci. B3 (1969) 153; Pennings, A. J., Kolloid Z. Z. Polym. (1973) 251, 500, each of which are incorporated by reference herein for their teachings of directional solidification of polymers). Films of two phase polymers can be stretched at temperatures above the melting temperature of the crystalline phase, and then crystal formation will be ordered along the direction of strain.

Nucleation and spherulite growth is another method of solidification that can be used in accordance with the invention herein. This method can be useful when a sample is heated above its melting point and subsequently cooled. As the sample cools, crystalline regions taking the form of thin platelets, i.e., lamella, begin to form. Generally, many lamella grow out of a central nucleus, forming structures called “spherulites.” In a spherulite, a thin amorphous region separates each flat crystalline lamella.

Using nucleation, the inventors herein have found that a homogenous or semi-homogenous polymer mixture of, for example, PEO/PMMA, can be spin cast onto a substrate and cooled below the glass transition temperature of both polymers. Nucleation can be initiated, for example, by a heated needle in a desired location. Alternatively, the polymer mixture can be heated above the cloud point or above the melting point of the crystalline phase of both polymeric components and then lowered below the melting temperature and nucleation can be initiated homogeneously or heterogeneously. The inventors herein believe that suitable heterogeneous nucleation sites could be impurities in the melt, solid particles (e.g., clays (Ferreiro, V., Douglas, J F., Amis, E. J., Karim, A., Macromol. Symp. (2001) 167, 73, which is incorporated by reference herein for its teaching of nucleation and spherulite growth), gas bubbles, holes, free surfaces, needles, or patterns of features that could introduce strain or local cooling sufficient to overcome the barrier to nucleation and induce crystallization in defined locations. By controlling the composition of the amorphous polymer mixture and the thermal gradient around the nucleation site, it is currently believed that a spherulite can be grown with the desired spacing between the crystallites or lamella and the desired thickness of the lamella.

Additionally, after the spherulites are grown to the desired size, they can, for example, be masked using photolithography for formation of microscale features by selective removal of the second polymeric component. That is, photolithography, which is a well known technique in the art, can be used to mask the two-component polymer mixture in various locations to prevent the second polymeric component from being removed by the removal methods detailed herein. With the second polymeric component left in the polymer mixture; it can be used to assist the partitioning of microfluidic channels to the polymer matrix.

Other methods of nucleation, which are known to those of ordinary skill in the art, can be used to produce and grow spherulites. For example, crystallization of PEO and PMMA mixtures results in segregation of PMMA into intercrystalline, interfibrullar, and interlamellar regions. Studies in the crystallization of spherulites of PEO/PMMA have been accomplished by a number of investigators (Pearce, R. and Vancso, G. J., J. Polymer Sci., Part B: Polymer Physics (1998) 36, 2643; Imai, S., Shimono, S., Fukushima, Y., Umezaki, K., Okada, M., Takahashi, M., Matsuda, H., Thermochimica Acta (1995) 267, 259; Richardson, P. H., Richards, R. W., Blindell, D. J., McDonald, W. A., Mills, P., Polymer (1995) 36, 3059; Radhakrishnan, S., Venkatachalapathy, P. D., Polymer (1996) 37, 3749, each of which are incorporated by reference herein for their teachings of crystallization of PEO/PMMA polymers). These spherulites grow with lamellar structures of alternating crystalline and amorphous phases. Since the self-assembly of the structure is controlled by solute diffusion, chain folding, and secondary nucleation, interlamellar structures can be about 10 nm (Schultz, J. M., Polymer (1991) 32, 3268), but can be as large as 1 mm (Kaiser, E. J., McGrath, J. J., Bernard, A., J. Appl. Polymer Sci. (2000) 76, 1516); these references are each incorporated by reference herein for their teaching of spherulite growth.

In general, polymeric mixtures have viscosities that are strong functions of temperature. In this regard, they are easy glass formers and can be cast in amorphous films by quenching or solvent evaporation. This provides two nucleation and directional solidification routes: 1) from the melt and 2) from the glass. In easy glass forming systems, the maximum growth rate often occurs at higher temperature than an appreciable nucleation rate, such that nucleation and growth of the crystalline phase can be separately controlled (Kingerly, W. D., Bowen, H. K., Uhlman, D. R. “Introduction to Ceramics,” John Wiley and Sons, N.Y. 1960; Gert Strobl “The Physics of Polymers, Concepts for Understanding Their Structures and Behaviors,” Springer-Verlag Berlin Heidelberg, Germany 1996, each of which is incorporated herein for its teaching of polymer crystal growth). Nucleation sites can be selected by local heating of the amorphous film or by local cooling from above the melting temperature of the crystal. Growth of crystals can be accomplished from the glassy state at low diffusion-rates, or from the melt at higher diffusion rates. This can give an extended range to the achievable length scales.

Also, two dimensional arrays of micro-patterned dots of a good thermal conductor are capable of being used as temperature controllers (e.g., heaters or coolers) to individually control the nucleation and growth of spherulites in polymer films. That is, the lamellar spacings of PEO films can be controlled by the temperature of the micropatterned dots. For example, a top and bottom plate that are micropatterned, ie., fabricated with normal photolithography and etching techniques from silicon or glass, or in polydimethly siloxane (PDMS) to contain microscale pores and wells, can be used to solidify the polymer mixture. The top plate can contain holes for the application of the two-component polymer mixture and the bottom plate can contain wells where the two-component polymer mixture resides. The bottom plate can also contain microfluidic channels that connect to the wells in some pattern. The top and bottom plates can be bonded together (e.g., by glue or anodic bonding). The substantially homogeneous liquid-like two-component polymer mixture can be injected through the top plate and into the wells of the bottom plate. An additional thermal control plate, which is a micropatterned plate fabricated from a heat conducting material (e.g., copper, platinum, silicon, and the like) with bumps or protuberances that fit through the holes of the top plate and into the wells of the bottom plate can be contacted to the plate assembly. The thermal control plate can then be heated above the cloud point of the polymer mixture. This top thermal control plate physically forms a well in the two-component polymer mixture and provides temperature control to the mixture. It can be used to establish a temperature gradient between the mixture and the bottom plate.

Nucleation of the first polymeric component can be accomplished by cooling the thermal control plate to a low temperature where the supercooling is sufficient to induce nucleation on the heterogeneous surface. After nucleation, the thermal control plate can be raised to the growth temperature and nanoscale patterns can be formed in the polymer matrix by crystallization. After the thermal control plate is removed, the second polymeric component can be removed by, e.g., exposing the assembly to ultraviolet light for bond scission of the second polymeric component. The second polymeric component can then be removed by solvent extraction.

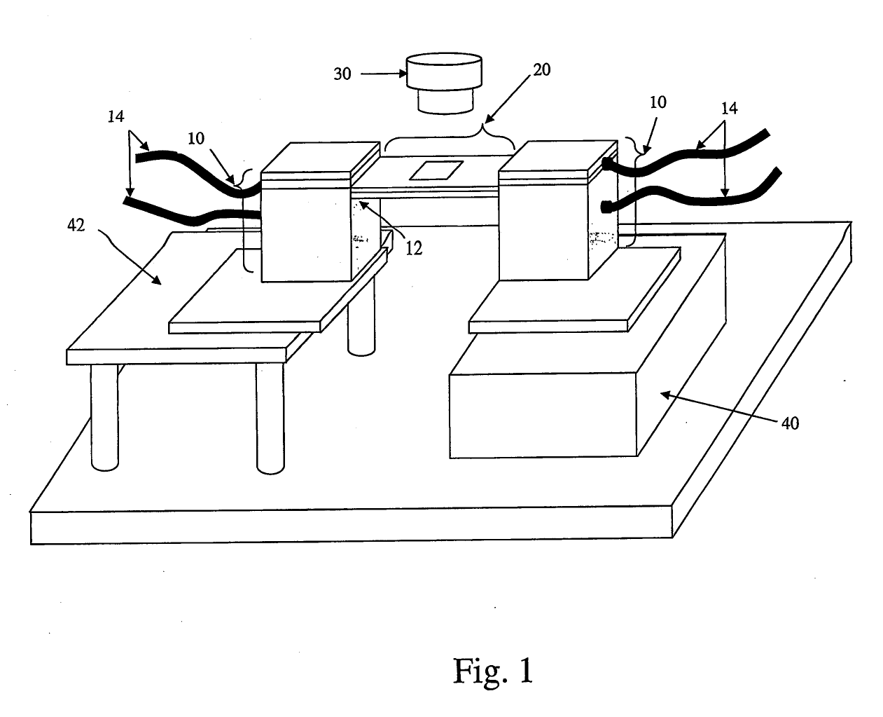

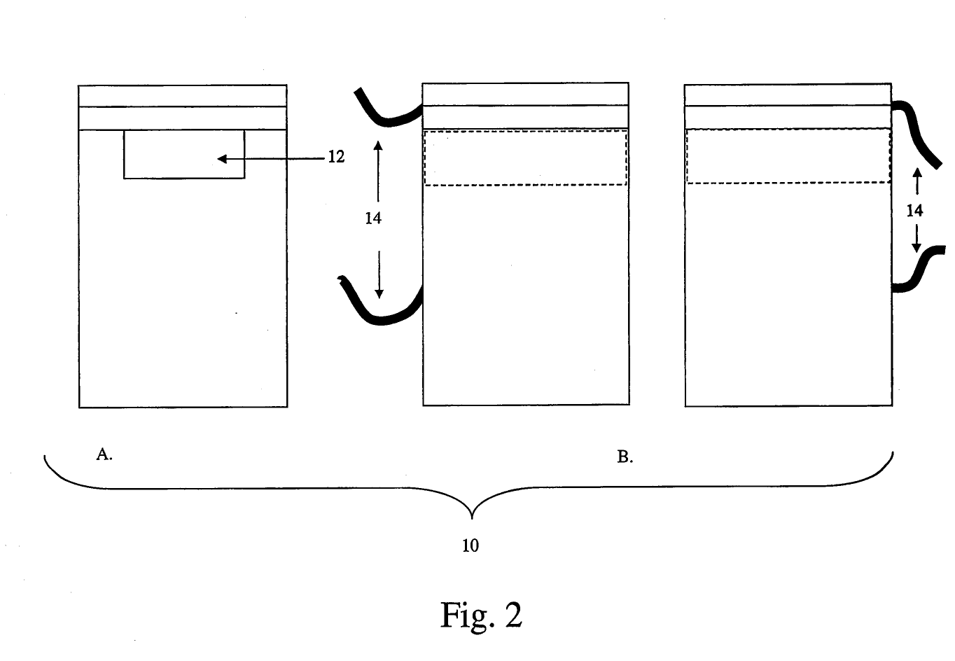

A device that can be used for directional solidification or nucleation and growth of spherulites is shown in FIGS. 1-3. FIG. 1 shows two heating/cooling blocks (10) that are situated such that the sample holder receptacle (12) of each block are facing each other. The blocks (10) can be moved in proximity close proximity to each other and controlled at different temperatures to establish a large thermal gradient. FIG. 2 shows a front view (labeled A) and side view (labeled B) of a heating/cooling block (10), with sample holder receptacle (12), and connectors (14). The sample holder receptacle can extend through the heating/cooling block (10) so that the sample holder (20) can be manipulated or moved through the blocks (10) without moving the blocks (10). A microstepper motor (not shown) can also be used to pull the sample holder (20) through the sample holder receptacle (12) in the blocks (10).

As shown in FIG. 1, inserted in the sample holder receptacle (12) of each block (10) is one end of a sample holder (20). Thus, the sample holder (20) forms a bridge like connection with the two heating/cooling blocks (10). One or both heating/cooling blocks (10) have connectors (14), which connect the heating/cooling bock (10) to a heating and/or cooling device (not shown). The connectors (14) can be electrical wires that connect the heating/cooling block (10) to an electrical heater and/or a chiller (not shown) to control the temperature of the heating/cooling blocks (10). Also, the connectors (14) can tubes through which a heated and/or cooled fluid (not shown), such as water, can be pumped through using a pump or faucet (not shown) through the heating/cooling block (10) to heat and cool the block. The heating/cooling blocks (10) can be made of any thermally conducing material. In one aspect, the heating/cooling blocks (10) are made of 6061 T6 aluminum.

As shown in FIG. 1, the heating/cooling blocks (10) can be placed on a stage (42) and/or a platform (40). Both the stage (42) and platform (40) can be made of a suitable insulating material, such as fiberglass. The platform (40) can also be supported by a jack or linear stage (not shown) so that the heating/cooling block (10) can be raised and lowered.

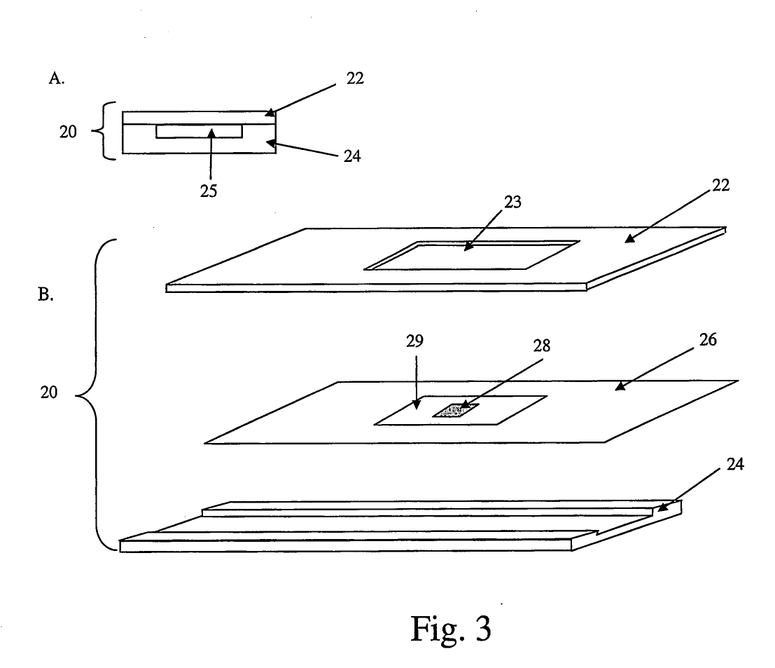

The sample holder (20) is shown in FIG. 3, the side view is labeled “A” and an expanded top-side view is labeled “B.” The sample holder (20) has a top plate (22) and a bottom plate (24). The plates can also be made of a thermally conducting material such as 6061 T6 aluminum. The top plate (22) can have a cut out window (23) through which to observe the solidification process. Also, the top (22) and bottom plates (24) connect in a way that leaves an area for the sample (25). The sample can contain a support (26), such as a glass microscope slide, a microchannel chip (28) that can receive the polymer mixture, and a PDMS cover (29). Also, to visualize the solidification process, above the solidifying apparatus can be a microscope (30) or some other optical viewing device.

After solidification, all or part of the second polymeric component can be removed from the two-component polymer mixture, thereby leaving nanoscale channels in the polymer matrix. That is, the spaces or voids created by the removal of one of the second polymeric components are the nanoscale channels within the polymer matrix.

In accordance with the invention herein, all of the second polymeric component can be removed from the pre-matrix. As used herein, the “pre-matrix” is the form of the polymer mixture after solidification of one or both of the polymeric components, but prior to removal of the second polymeric component. Thus, the pre-matrix can be the first and second polymeric components present as substantially crystalline forms. Alternatively, the pre-matrix can be the second component present as a substantially non-crystalline form and the first polymeric component present in a substantially crystalline form.

In accordance with the present invention, at least a portion of the second polymeric component can be removed from the pre-matrix. A portion of the second polymeric constituent that can be removed can be about 100, 90, 80, 70, 60, 50, 40, 30, 20, 10, or 1% of the amount of the second polymeric component in the pre-matrix, where any of the stated values can comprise an upper or lower endpoint, as appropriate. A portion of the second polymeric component that can be removed can be about 95, 85, 75, 65, 55, 45, 35, 25, 15, or 5% of the amount of the second polymeric component in the pre-matrix, where any of the stated values can comprise an upper or lower endpoint, as appropriate. A portion of the second polymeric component that can be removed can be about 97, 87, 77, 67, 57, 47, 37, 27, 17, or 7% of the amount of the second polymeric component in the polymer mixture, where any of the stated values can comprise an upper or lower endpoint, as appropriate. A portion of the second polymeric component that can be removed can be at least about 100, at least about 90, at least about 75, at least about 50, at least about 25, or at least about 1% of the amount of the second polymeric component in the polymer mixture. One of ordinary skill in the art can determine the amount of the second polymeric component to remove from the pre-matrix based on the particular end use purposes, the amount nanoscale channels desired, and so forth.

Removal of all or a portion of the second polymeric component from the pre-matrix can be accomplished by, for example, exposing the pre-matrix to electromagnetic radiation (e.g., UV light, Infrared light, microwaves, and the like) so as to degrade the second polymeric component (that is, the polymer that is removed from the pre-matrix) followed by contacting the pre-matrix with a solvent. Such methods of removal the second polymer component can be readily determined by one of ordinary skill in the art without undue experimentation by consulting publicly available sources regarding the properties of polymers.

Alternatively, or in addition to the above removal methods, removal can be accomplished by contacting the pre-matrix with a suitable solvent after solidification of one or both of the first and second polymeric components. Such suitable solvents that can be used to remove the second polymeric component are readily commercially available and can be chosen by one of ordinary skill in the art depending on the particular polymers used in the first and second polymeric components. For example, suitable solvents can include, but are not limited to, acetic acid, propanoic acid, butyric acid, hydrochloric acid, sulfuric acid, trifluoroacetic acid, phosphoric acid, methanol, ethanol, propanol, butanol, ether, ethyl acetate, chloroform, methylene chloride, dichloroethane, acetone, methyl ethyl ketone, acetonitrile, dimethyl formamide, toluene, benzene, dimethyl sulfoxide, water, or mixtures thereof. The appropriate solvent would be selective in that the first polymeric component would not be measurably soluble in the solvent, but the second polymer component would have substantial solubility in the solvent. One of ordinary skill in the art can determine the method of removing the second polymeric component based on the particular polymers present in the first and second polymeric components without undue experimentation.

Further, the second polymeric component can be removed from the pre-matrix by, for example, treating the pre-matrix with reagents that will react with the second polymeric component and convert it into a form that can be removed with a suitable solvent, as noted above, or into a form that can be evaporated at a suitable temperature.

In a further aspect, after removal of the second polymeric component, the remaining nanoscale channels in the polymer matrix can be functionalized. That is, the functional groups of the polymer matrix at the interface of the polymer matrix and nanoscale channels can be contacted with a functional reagent. By “functional reagent” is meant a reagent that reacts with functional groups on the polymer matrix to improve bonding to a substrate, to change the hydrophobicity or surface properties of the polymer crystallites, or to react with analytes in the nanoscale channels. In one aspect, a functional reagent can be used to convert the functional groups of the polymer matrix to hydrophilic moieties, reactive moieties, and the like. Suitable functional agents can include acids and bases. The functional reagent can be applied to the polymer matrix by immersing the matrix in the functional reagent or by passing the functional reagent through the nanoscale channels of the polymer matrix.

The polymer matrix having nanoscale channels of the present invention can have many uses, such as detecting, separating, characterizing, and/or reacting compounds. The polymer matrix can be used for such functions alone by passing compounds through the nanoscale channels as described herein or the polymer matrix can be affixed to a support substrate to create a separating device. Such a device is not a hydrogel or hydrophobic membrane.

In one aspect, one or more of the polymer matrixes having nanoscale channels of the present invention can be arranged onto a generally planar support substrate to form a chip. These chips can have an array of nanoscale channels in which and through which compounds and reagents can be detected, separated, characterized, analyzed, and/or reacted.

The components of the chip should be compatible with the particular analytes and reagents with which the chip is to be used and come into contact. For example, the chip can be used to separate biomolecules by filtration; hence, the chip should not react with, degrade, or have any deleterious impact on the particular compounds that are to be filtered. Also, the chip should be stable towards and resist degradation from typical solvents used in biological applications and preparations, such as water, mild acids and bases, and buffers.

The chip can generally have an area on the scale of cm². A typical chip will have an area of from about 100 cm² to about 1000 cm², from about 10 cm² to about 100 cm², or from about 1 cm² to about 10 cm². The chip can have an area less than 100 cm². The chip can have an area less than 10 cm² in size. The chip can have an area in the range of about 1, 2, 5, 10, 15, 25, 50, 100, 150, 250, 500, 750, 1000, 1250, 1500, or 2000 cm², where any of the stated values can comprise an upper or lower endpoint, as appropriate. The particular size of the chip can be determined by one of ordinary skill in the art based on the end use purposes of the chip or on convenience.

Also, the chip can be made in many different shapes. For example, the chip can be generally planar with a square, rectangular, triangular, or irregular shape. The particular shape will also depend on the end use purposes of the chip or on convenience.

The chip of the present invention can, for example, be used with sample volumes on the picoliter, nanoliter, microliter, and/or milliliter scale.

In another aspect, the polymer matrixes having the nanoscale channels of the present invention can be placed into a columnar or tubular support substrate, which can be used to separate compounds or analytes. In such an aspect, the columns of the present invention can have various dimensions. For example a column can have a diameter of from about 0.1 mm to about 10 mm and a length of from about 10 cm to about 10 m, like those used in gas chromatography. Alternatively, the column can have a diameter of from about 10 mm to about 300 mm and a length of about 10 mm to about 3 m, like those used in liquid chromatography (e.g., HPLC, flash, etc.). In one aspect, the column can be a capillary column.

In further aspects, the columns of the present invention, like the chips, can, for example, be used with sample volumes on the picoliter, nanoliter, microliter, and/or milliliter scale.

The chips of the present invention can be prepared by affixing the polymer matrix to the support substrate after the nanoscale channels have been formed, i.e., after solidification of the two-component polymer mixture and removal of the second polymeric component. In this case, the polymer matrix can be affixed onto the support substrate by applying a film of the polymer matrix to the substrate. The chips of the present invention can also be prepared by affixing the homogeneous two-component polymer mixture to the support substrate by, for example, spin casting, spray coating, contact printing, or dipping, then solidifying the mixture and removing the second polymeric component, as described in detail herein.

The columns of the present invention can be prepared by methods similar to those used for the chips. For example, the polymer matrix with nanoscale channels can be placed inside the column. Alternatively, the two-component polymer mixture can be placed inside the column followed by solidification and removal of the second polymeric component to result in column with a polymer matrix with nanoscale channels therein.

As noted above, the substrate typically functions as a support for the polymer matrix with nanoscale channels. The substrate support of the device can be made of material that is readily commercially available and/or can be prepared by methods known to one of ordinary skill in the art. The substrate can be made from any material that does not affect, interfere with, or in anyway diminish the polymer matrix's particular end use purposes. Thus, substrate materials that could react with, change, alter, or degrade a desired compound or analyte for which the device is being used should be avoided.

Suitable materials for the substrate, or “support form,” can include, but are not limited to, silicon, coatings on silicon (e.g., silicon nitride), silicone, glass, quartz, platinum, stainless steel, copper, aluminum, and/or plastics (e.g., high-density polyethylene, polyethylene terephthalate, and/or polycarbonate). The particular support form to be used in a particular device can be determined by one of skill in the art without undue experimentation based on the particular end use purposes of the device.

The columns or chips of the present invention can be coupled to or integrated with one or more apparatus to detect the presence or absence of a particular analyte or compound. A typical detection apparatus can be capable of high throughput and sensitive detection of the specific compound or analyte for which the device is used to separate and characterize. Such a detection apparatus can be an optoelectronic detector. Other examples of a detection apparatus that can be used with the disclosed device can include, but are not limited to, a UV detector, refractive index detector, fluorescence detector, conductivity detector, electrochemical detector, FTIR detector, thermal conductivity detector, flame ionization detector, photoionization detector, mass spectroscopy detector, colorimetric detector, and other common analytical detectors known to one of ordinary skill in the art. The choice of the detection apparatus can be determined by one of ordinary skill in the art depending on the particular compound or analyte that the device is being used to separate or characterize.

The present invention further provides a method for separating and characterizing materials using the disclosed polymer matrixes having nanoscale channels. In one aspect, a sample that contains materials to be separated is provided.

Particular materials that are amenable to separation and characterization using the disclosed polymer matrixes can include, but are not limited to, biological molecules, polymers, carbohydrates, lipids, organometallic complexes, and catalysts. Specific examples of materials that can be separated and characterized can include, but are not limited to, DNA, RNA, nucleotides, nucleic acids, proteins, peptides, sugars, lipids, bioactive molecules that effect fungal growth, viruses, toxins, cellular organelles (e.g., food vacuoles, lysosomal compartments, golgi), and blood and cell receptors/ligands. Accordingly, samples containing mixtures of these various materials are suitable for use in the present invention.

The samples can contain materials of different sizes. Also, the samples can be a dilute solution of materials, a concentrated solution of compounds, a colloidal suspension, or an emulsion. The sample can be an aqueous solution or an organic solution. The sample can be in the gaseous state.

Separations of the materials discussed herein, as well as other materials, are important in their characterization and in understanding their function. One element that can have a broad impact can be the separation of nucleic acids (DNA). Several investigators have used nanosized passages to separate DNA (Han, J. and Craighead, H. G., Science (2000) 288, 1026; Saleh, O. A. and Sohn, L. L., Nano Letters (2002) in press; Chou, H. P., Spence, C., Scherer, A., Quake, S. A., Proc. Nat. Acad. Sci. U.S.A. (1999), 96, 11), the disclosures of which are incorporated in their entireties for the disclosure of DNA separations. The present invention provides an alternate technique by which to prepare and use nanoscale devices to separate, analyze and/or characterize materials such as DNA.

In accordance with the present invention, the polymer matrix having nanoscale channels and the sample are contacted by any method known in the art. Suitable methods of contacting can include, but are not limited to, injecting the sample onto the polymer matrix, pipetting the sample onto the polymer matrix, pouring the sample onto the polymer matrix, immersing the polymer matrix in the sample, or placing the polymer matrix on the sample and letting the sample move into the nanoscale channels through a wicking action. For example, the sample can be injected into the center of the spherulite and extracted from the periphery through the nanoscale channels by electrokinetics or pressure driven flow.

The sample can be moved through the polymer matrix in any manner known to one of ordinary skill in the art. For example, a vacuum can be applied to facilitate the movement of the sample through the nanoscale channels of the polymer matrix. An electric potential can be applied to the polymer matrix to facilitate the movement of the sample through the nanoscale channels. Gas can be allowed to flow over and/or through the polymer matrix to facilitate the movement of the sample through the nanoscale channels.

Typically, electricity can be used to drive the sample through the nanoscale channels. For example, in electro-osmosis, computer-driven power supplies located at each end of a channel are activated to generate electrical current through the polymer matrix. The current forces compounds with different electrical charges in the sample to travel through the nanoscale channels at different rates.

Other methods of driving the sample through the polymer matrix can also include, for example, applying small amounts of pressure to the sample traveling through the nanoscale channels. Also, temperature gradients can move tiny volumes of liquids around nanoscale channels. This typically occurs because the surface tension of the sample varies with temperature; thus, a temperature gradient of just three or four degrees can be enough to cause a sample to seek a cold region in its pathway.

After the sample has passed through the nanoscale channels, compounds can be detected, collected, isolated, and/or characterized. For example, when the polymer matrix is integrated with a detection apparatus, as described above, the compound of interest will pass into the detection apparatus and generate a signal. Also, compounds can be isolated from the polymer matrix by, for example, standard blotting transfer protocols or electrokinetic transfer from the nanoscale channels to an appropriate transfer blotter substrate (e.g., nitrocellulose). Such transfer methods are known to one of ordinary skill in the art and/or can be found in methods of protein analysis in which proteins separated by gel electrophoresis are transferred to a nitrocellulose blotter for amino acid analysis.

The compounds, materials and polymers of the invention can be readily synthesized using techniques generally known to synthetic organic chemists, or they can be obtained from commercial sources.

Methods for making specific and preferred compounds of the present invention are described in detail in the Examples below.

### EXAMPLES

The following examples are put forth so as to provide those of ordinary skill in the art with a complete disclosure and description of how the compounds, compositions, articles, devices, and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.) but sore errors and deviations should be accounted for. Unless indicated otherwise, parts are parts by weight, temperature is in ° C. or is at ambient temperature, and pressure is at or near atmospheric.

### Example 1

Equal amounts (by weight) of PMMA (MW 120,000; Aldrich Chemical; Milwaukee, Wis.) and PEO (MVW 2,000,000 Aldrich Chemical) were blended in a chloroform solvent and mixed for 40 hours at 35° C. until both polymers were dissolved in the solvent. The mixture was pored into a watch glass and the solvent was allowed to evaporate, leaving a solid film of the polymer mixture. A small piece (3 mm×3 mm) of this film was cut out and placed on a microscope slide. The slide and polymer film were heated to 140° C. (above the cloud point of the mixture) and a glass cover slip pressed onto the film and glass slide. The mixture was allowed to cool to room temperature.

The slide, polymer mixture, and cover slip assembly was placed on adjacent temperature controlled aluminum blocks on a microscope stage (FIG. 1). The temperature of the blocks was held at 10° C. overnight to stimulate the nucleation of spherules in the film. After 20 hours, the PEO component in the film was crystallized. The two blocks were then raised to the applicable growth temperature.

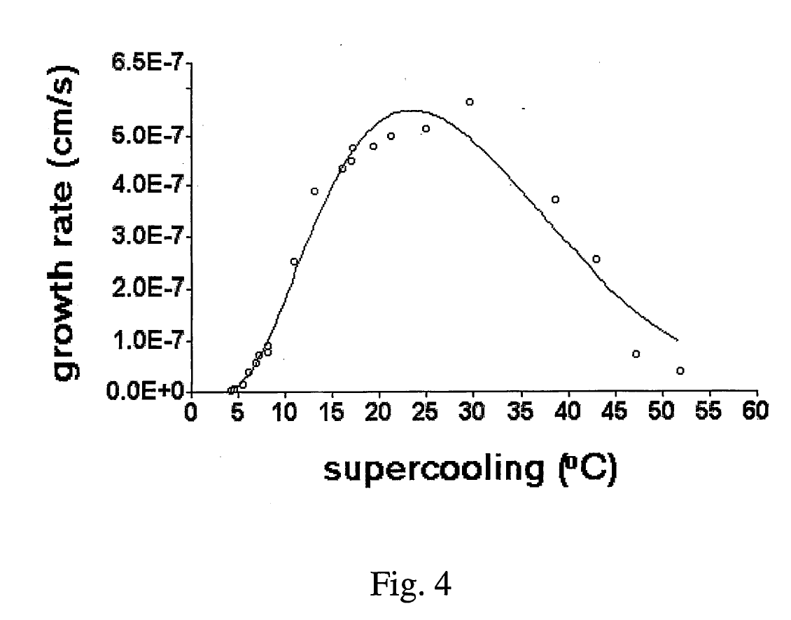

In this experiment temperatures from 10° C. to 60° C. were tested. A graph of the growth velocity of a blend of 50% PEO and 50% PMMA as a function of isothermal growth temperature is in FIG. 4.

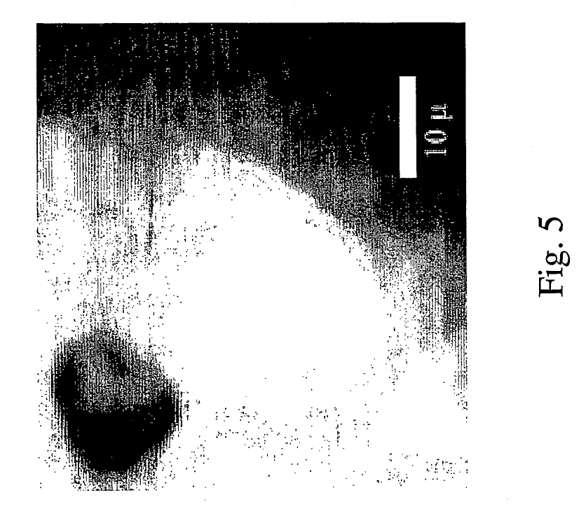

When the sample stabilized at the desire temperature, the PEO component was melted by raising the temperature of one of the blocks to above the melting temperature of PEO with an auxiliary heater. After melting of the existing spherulites was observed, the auxiliary heater was turned off, and the polymer was allowed to return to the growth temperature. As the spherulites grew, images of the growth front were obtained with a CCD camera mounted on the microscope (FIG. 5). The images were analyzed to determine the velocity of the advancing solidification front. The lamellar structure of the PEO is visible with polarized light optical microscopy.

In this sample, 10° C. was a temperature where the nucleation rate is high and growth rate low due to the limit of diffusion. To state differently, the free energy difference between the crystal and the undercooled liquid (or amorphous phase) always increases as the temperature is lowered. The nucleation rate, however, depends on this driving force and the ability of the molecules to rearrange or diffuse across the solid/liquid boundary. In easy glass forming systems (such as PMMA and PEO) the viscosity or mobility increases exponentially with decreasing temperature—so even the driving force is increased, the mobility is too low to allow crystallization. Therefore, the nucleation temperature must be chosen by one skilled in the art, and for the Example 1 it was 10° C. and took about 2 hours.

### Prophetic Example 2

For directional solidification a channel 100×100 μm×10 mm is formed in PDMS and bonded to a glass slide. One millimeter holes are drilled in the PDMS at the ends of the channel. A 50:50 mixture of PEO and PMMA is prepared as before (chloroform solution-watch glass). A piece of the mixture is placed on a hot plate, melted, and drawn into a stainless steel needle slightly less than 1 mm o.d. The needle is contained in a heater block so that the temperature of the needle could be controlled. The PDMS channel assembly is placed on the heating/cooling blocks (10) under the optical microscope.

The temperature of the PDMS structure is raised to 80° C., and the polymer mixture is injected into the channel using a syringe pump. Needle temperature is about 100° C. Air pressure is used to force the plug of polymer material into the center of the channel. The entire structure (blocks and glass slide with channel and PEO/PMMA mixture) is lowered to 10° C. and held overnight to completely crystallize the sample. The right block is held at the desired crystallization or growth temperature, and the left block is heated to 80° C. to “melt back” the polymer toward the cold block. Melting can be observed in the microscope. Afterwards, the temperature of the left block is lowered to establish the gradient for the solidification experiment. A gradient of 10° C. per mm can be used. Solidification was observed using optical microscopy with polarized light.

When the solidification front is established, the stage is translated from left to right at a rate to establish steady state growth conditions at the interface. These conditions are approximately the velocities established in the isothermal spherule growth experiment of Example 1. For example, if the interface (solid/liquid) temperature is 33° C., the “pull rate” or stage traverse velocity would be 20 μm per hour. If the target interface temperature were 55° C. the initial pull rate would be 5 μm per hour. The experiment is continued until the interface moved to the end of the sample. These conditions set up a quasi-steady state solidification condition in the sample.

### Prophetic Example 3

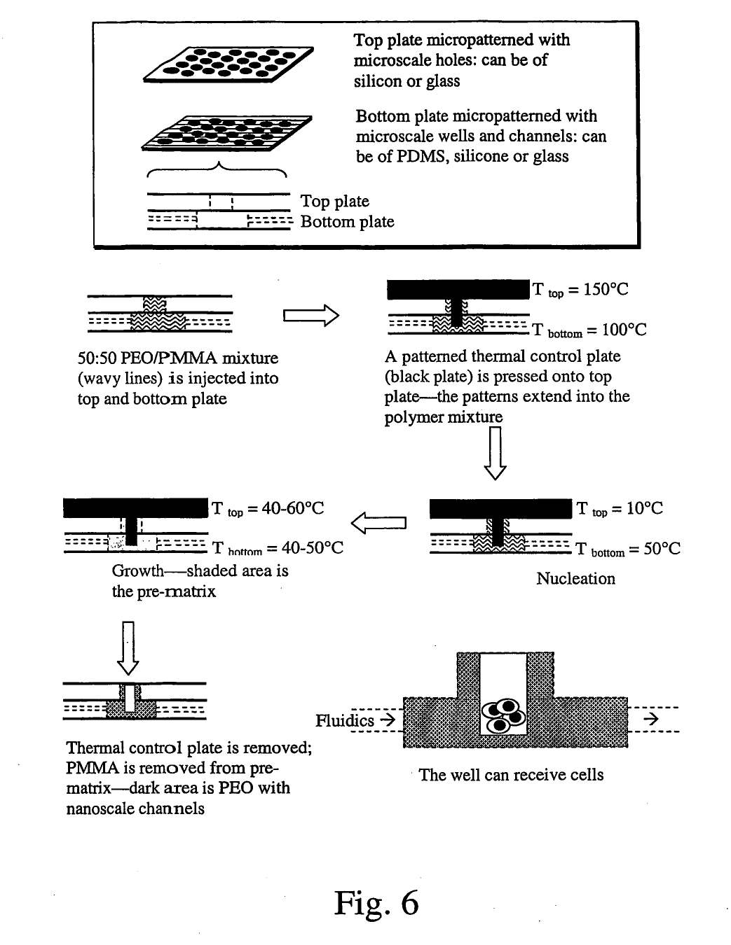

Cell lyser for separating the biomolecules from the contents of a lysed cell (FIG. 6):

First, a micropatterned top and bottom plate are fabricated with normal photolithography and etching techniques from silicon or glass, or in polydimethly siloxane (PDMS). The top plate contains holes for the application of a poly(ethyleneoxide)/poly(methylmethacrylate) (PEO/PMMA) polymer mixture for the nanoscale filter and for eventual delivery of the cell. The bottom plate contains a well connected to microfluidic channels where the PEO/PMMA mixture is to reside. The plates are bonded together (by glue or anodic bonding). The polymer mixture is injected into the well. An additional micropatterned plate is fabricated from a heat conducting material (e.g., copper, platinum, silicon, and the like) with bumps or protuberances that fit in the wells on the micropatterned chip.

The assembly is heated above the cloud point for the insertion of the top patterned plate. This top thermal control plate physically forms a well in the PEO/PMMA mixture and provides temperature control to the mixture. It is used to establish a temperature gradient between the mixture and the bottom plate.

Nucleation of the PEO crystals is accomplished by cooling the thermal control plate to a low temperature (˜10° C.) where the supercooling is sufficient to induce nucleation on the heterogeneous surface.

After nucleation, the top plate is raised to the growth temperature and nanoscale channels are formed in the PEO by crystallization. The thermal control plate is removed, and the assembly exposed to ultraviolet light for bond scission of the PMMA. The PMMA is then removed by solvent extraction.

A cell is introduced into the well and lysed by electrical discharge or mechanical means, and the contents are removed by fluid flow or electrophoresis. Cell contents are removed through the nanoscale channels and are collected in the microfluidic channels for identification.

### Prophetic Example 4

A bioactive compound filter for separating small environmental toxins from the contents of a collected sample:

First, a micropatterned top and bottom plate are fabricated with normal photolithography and etching techniques from silicon or glass, or in PDMS. The top plate contains holes for the application of the PEO/PMMA mixture for the nanoscale filter and for eventual delivery of the cell. The bottom plate contains a well connected to microfluidic channels where the PEO/PMMA mixture is to reside. The plates are bonded together (by glue or anodic bonding). The polymer mixture is injected into the well. An additional micropattetned plate is fabricated from a heat conducting material (e.g., copper, platinum, silicon, and the like) with bumps or protuberances that fit in the wells on the micropatterned chip.

The assembly is heated above the cloud point for the insertion of the top patterned plate. This top thermal control plate physically forms a well in the PEO/PMMA mixture and provides temperature control to the mixture. It is used to establish a temperature gradient between the mixture and the bottom plate.

Nucleation of the PEO crystals is accomplished by cooling the top plate to a low temperature (˜10° C.) where the supercooling is sufficient to induce nucleation on the heterogeneous surface.

After nucleation, the top plate is raised to the growth temperature and the nanoscale patterns formed in the PEO by crystallization. The thermal control plate is removed, and the assembly exposed to ultraviolet light for bond scission of the PMMA. The PMMA is then removed by solvent extraction.

An environmental sample previously passed through a 0.25 micrometer filter (in which cells and particulate matter have been removed) is introduced into the well and the contents are removed by fluid flow or electrophoresis. Analyte molecules present in the environment are removed through the nanoscale channels and are collected in the microfluidic channels for identification.

Throughout this application, various publications are referenced. The disclosures of these publications in their entireties are hereby incorporated by reference into this application in order to more fully describe the state of the art to which this invention pertains.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of making a polymer matrix having nanoscale channels comprising the steps of:
a. selecting a first and a second polymeric component each having a melting temperature,;
b. mixing the first and second polymeric components under conditions sufficient to provide a substantially homogeneous polymer mixture;
c. solidifying one or both of the polymeric components to provide a pre-matrix wherein the second polymeric component is at least partially crystalline; and
d. removing at least a portion of the second polymeric component from the pre-matrix, thereby providing a polymer matrix having nanoscale channels.

2. The method of claim 1, wherein the condition of step b comprises heating the first and second polymeric components to a temperature greater than the melting temperature of the polymeric component having the highest melting temperature.

3. The method of claim 1, wherein the first polymeric component is polyethylene oxide and the second polymeric component is poly(methyl)methacrylate.

4. The method of claim 1, wherein the first and the second polymeric components are present as a block copolymer.

5. The method of claim 1, wherein the solidification step is by nucleation and growth of spherulites.

6. The method of claim 1, wherein the solidification step is by directional solidification.

7. The method of claim 1, wherein the removing step comprises contacting the pre-matrix with a solvent suitable to dissolve the second polymeric component, wherein the solvent does not substantially dissolve the first polymeric component.

8. The method of claim 1, wherein the removing step is by exposing the pre-matrix to electromagnetic radiation, followed by contacting the pre-matrix with a solvent suitable to dissolve the second polymeric component, wherein the solvent does not substantially dissolve the first polymeric component.

9. The method of claim 1, wherein the nanoscale channel has a diameter of less than about 750 nanometers.

10. The method of claim 1, wherein a functionalizing material is passed through the polymer matrix after step d so as to provide a functionalized polymer matrix.

11. A device for separating materials, comprising the polymer matrix having nanoscale channels of claim 1 and a support form.

12. The device of claim 11, wherein the support form comprises one or more of silicon, silicon nitride, silicone, glass, quartz, platinum, stainless steel, copper, aluminum or plastic.

13. The device of claim 11, further comprising a detector.

14. The device of claim 13, wherein the detector comprises one or more of an optoelectronic detector, UV detector, refractive index detector, fluorescence detector, conductivity detector, electrochemical detector, FTIR detector, thermal conductivity detector, flame ionization detector, photoionization detector, mass spectroscopy detector or colorimetric detector.

15. A method for separating materials, the method comprising:
a. providing a sample comprising materials having differing sizes;
b. contacting the sample with the polymer matrix having nanoscale channels of claim 1; and
c. separating the desired materials.

16. The method of claim 15, further comprising directing a least a portion of the separated materials through a detector.

17. The method of claim 15, wherein the materials comprise one or more of DNA, RNA, nucleotides, nucleic acids, proteins, peptides, sugars, lipids, bioactive molecules that affect fungal growth, viruses, toxins, cellular organelles, or blood and cell receptors or ligands.
